(19) United States
(12) Patent Application Publication
(10) Pub. No.: US 2012/0269641 A1
(43) Pub. Date: Oct. 25, 2012

(54) Wind Turbine Rotor Blades Sharing Blade Roots for Advantageous Blades and Hubs

(76) Inventor: Anthony Chessick, Tehachapi, CA (US)

(21) Appl. No.: 13/453,747

(22) Filed: Apr. 23, 2012

Related U.S. Application Data
(60) Provisional application No. 61/517,629, filed on Apr. 22, 2011.

(51) Int. Cl. F03D 11/00; F03D 1/06

(52) U.S. Cl. 416/223 R

(57) ABSTRACT

A wind turbine blade grouping includes at least two wind turbine blades. Each of the blades includes a blade root. The blade roots merge to form a single, unitary blade base structure that can be attached to a wind turbine hub.

### RELATED APPLICATIONS

This Application claims priority of U.S. Provisional Application No. 61/517,629, entitled “Wind Turbine Rotor Blade Roots for Advantageous Blades and Hubs,” and filed on Apr. 22, 2011. The Provisional Application is incorporated herein by reference in its entirety.

### BACKGROUND OF THE INVENTION

1. Field of the Invention

The present invention relates generally to wind turbines, and more specifically to wind turbine rotor blades and blade hubs.

2. Background

Horizontal axis wind turbines are known in the art. As turbine power capacity ratings have increased, blade lengths have increased, resulting in higher blade tip speeds, lower rotor rotation speeds, or both. In addition, blade roots have become large and heavy to support the added length of the blades. Although blade roots are heavier than the remainder of the blade, the roots themselves are responsible for very little power production. Thus, an increased size and weight of blade roots is a net loss for energy production. The focus in the art has been on composite materials engineered to extend blade lengths while simply accepting the consequences of disproportionalities in blade length and blade root size and weight.

Further, advances in the art suggest that thinner blades are more efficient than thicker blades, leading to a greater disproportionality between the weight of blades and the weight of blade roots. Thinner blades also result in noticeable blade bend-back during blade bending moments. Energy conversion is directly related to tangential blade speed, but tangential blade speed also increases the blade axial force, causing bend-back. In the prior art, blade cross-sectional thickness and the material strength and stiffness of the blades are used to address bend-back.

### SUMMARY OF THE INVENTION

The present invention provides a wind turbine blade grouping including at least two wind turbine blades. Each of the blades includes a blade root. The blade roots merge to form a single, unitary blade base structure.

Another aspect of the present invention provides that the blade base structure includes at least one fastener for fastening the blade base structure to the hub of a wind turbine.

Another aspect of the present invention provides that the turbine blades of the blade grouping are of substantially the same length.

Another aspect of the invention provides structural reinforcements extending from a first wind turbine blade to a second wind turbine blade.

Another aspect of the invention provides that the wind turbine blade profiles reduce drag and allow faster blade rotation.

Another aspect of the present invention provides a wind turbine blade assembly having at least two wind turbine blades, a first blade flange fixedly attached to a first wind turbine blade and a second blade flange fixedly attached to a second wind turbine blade, where the two blade flanges are attached to one another to form a single turbine blade assembly.

Another aspect of the present invention includes a hub flange adapted to receive the first blade flange and the second blade flange to form a single wind turbine blade assembly. The hub flange is also adapted to be fixedly attached to a wind turbine hub.

Another aspect of the invention provides a horizontal axis wind turbine including a hub and a plurality of wind turbine blade groupings. Each blade grouping includes at least two wind turbine blades, each having a blade root, the roots coming together to form a single blade base structure.

### BRIEF DESCRIPTION OF THE DRAWINGS

FIG. 1 depicts a standard horizontal axis wind turbine as known in the art.

FIG. 2 depicts a turbine blade root assembly constructed in accordance with the teachings of the present invention.

FIG. 3 depicts a turbine blade grouping of the present invention, the blade grouping being mounted on a hub.

### DETAILED DESCRIPTION OF THE INVENTION

The present invention provides advances in wind turbine blade design. The driving force at any location along a turbine blade length involves the following equations:

F=ρVΓ

F̅=\dot{m} ∇̅V

Thus, the mass flow factor and a “circular,” Γ, or angular deflection factor, ∇V, play an important role. As turbine blade length increases, there is a greater reliance on the mass flow factor nearer the blade tips, supported by a minimization of viscous blade drag. Such an aerodynamic approach differs from mainstay aviation aerodynamics in that viscous drag plays a more important role in performance, isolated from the induced drag or “drag penalty of lift”, which is not found in the geometry of wind energy blade aerodynamics. Here blade profiles are given additional freedom to address blade viscous drag.

Moving outwards along the blade toward the blade tips increases the blade tangential velocity and thereby the mass flow rate factor, reducing the “facing” of the wind turbine blade (the aspect of the blade seen frontally, ahead of the blade, by the incident wind, approaching as it is, at an angle). The blade affects and processes less of the flow farther away from the blade surfaces. It has been discovered that added facing may be gained by providing a second wind turbine blade at some lateral distance from a first wind turbine blade, as set forth herein. A gap is provided between the blades, the width of the gap being determined by the distance past which the effect of the first blade has been reduced to a degree which makes adding such an additional blade airfoil worthwhile.

Tangential speed ratio is equal to the tangential speed of a selected location on a wind turbine blade, divided by the wind speed impacting the leading edge at that location. At a tangential speed ratio greater than six, the wind incidence angle of the leading edge of the wind turbine blade is reduced to less than ten degrees off of the blade path in the rotor plane. At such small angles, two blades placed side by side, with a suitable gap between, have less interference with each other than it appears from a view upwind.

The present invention also addresses blade bend-back deflection. Bracing structural reinforcements are provided between turbine blades. Because blade thickness is not used in the present invention to address bend-back, blade thickness can be reduced, with the added benefits of a reduction of viscous blade drag and increased blade tip speeds. The blade bend-back deflection due to cantilevering from the bend-back force can be said from structural design theory to be as the fifth power of the blade distance along the blade length. Clearly, the high tensile modulus (stiffness) of composites blade materials has been relied on to a great extent to make possible the success of wind energy.

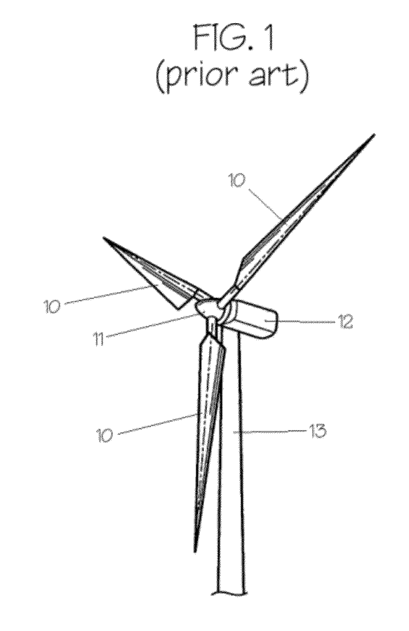

Turning now to the drawings, wherein like numerals indicate like parts, FIG. 1 depicts a typical horizontal axis wind turbine known in the art. The wind turbine of FIG. 1 includes blades 10 mounted on hub 11, fastened to a main shaft (not shown) that enters nacelle 12. This assembly is mounted on a tower 13 and used to turn a generator or otherwise perform useful work.

The present invention includes a wind turbine blade “grouping,” wherein two or more blades effectively share a single blade root. This may be accomplished through manufacture of a unitary structure, such that a single blade root extends to form two or more blades as a unitary portion thereof, or may be constructed as a blade root assembly, wherein individual blade roots are physically attached to form a single, larger blade root. It is contemplated that the blades are of substantially the same length, though in some embodiments one blade length could be significantly shorter than another. Further, in other embodiments of the invention a blade tip may be split for some portion of the blade length, forming two smaller blades from some portion of the original blade.

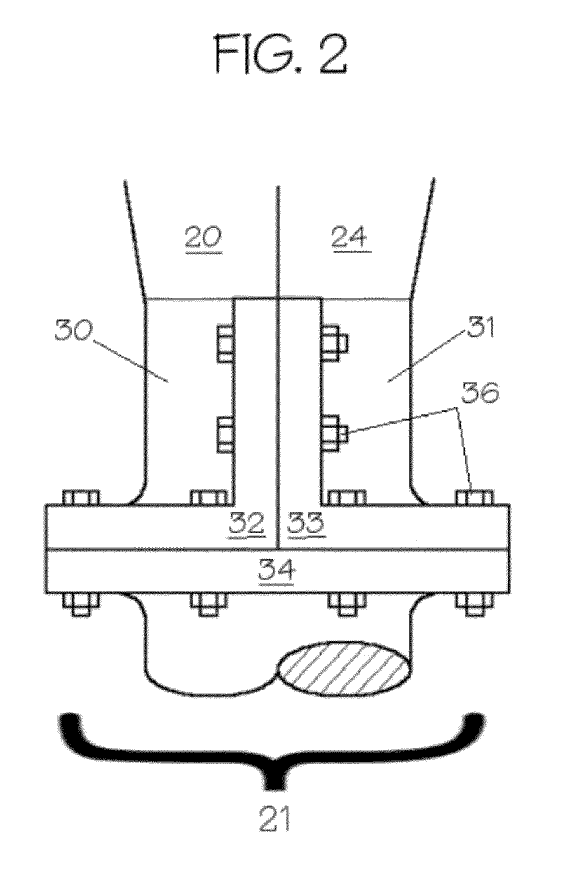

FIG. 2 depicts one embodiment of a blade root assembly of the present invention. Wind turbine blades 20 and 24 include blade roots 30 and 31, respectively. Blade roots 30 and 31 are joined together, effectively forming a single blade root assembly 21. In the embodiment of the invention shown in FIG. 2, forward blade 20 is attached to a forward blade flange 32, and aft blade 24 is attached to an aft blade flange 33. The two blade flanges 32 and 33 are attached to hub flange 34. A plurality of fasteners 36 are used in the attachment of the various flanges, though it is understood that any suitable attachment mechanism may be used. The blade flanges and hub flanges of the present invention may be internal or external. In an external blade flange, the diameter of the bolt circle is preferably greater than the diameter of the blade root or hub. In an internal flange, the diameter of the bolt circle is preferably less than the diameter of the blade root or hub. The embodiment of the present invention shown in FIG. 2 includes external flanges.

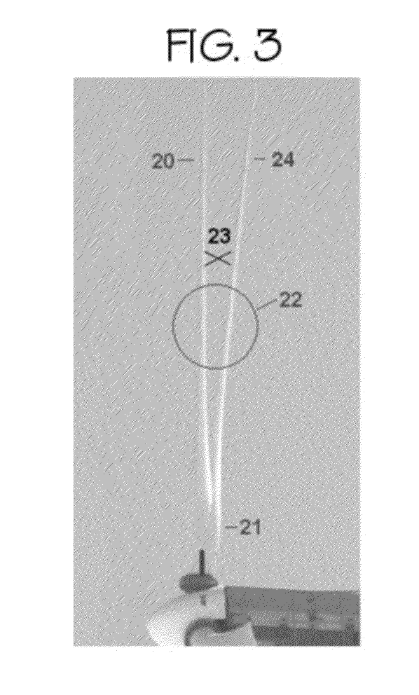

As shown in FIG. 3, the assembled wind turbine blades 20 and 24 form a blade grouping 22. A blade grouping 22 takes the place of a single blade in a conventional wind turbine known in the art. Although the blade groupings 22 shown in the drawings include two blades, it is contemplated that a single blade grouping may include more than two blades. As can be seen, replacing the blades on a standard three-blade wind turbine with three of the blade groupings shown in FIG. 2 will result in a wind turbine having six blades. Also shown in FIG. 3 is the placement of structural reinforcements 23, which provide reinforcement in embodiments of the present invention wherein such reinforcements 23 are utilized. In addition to cross-bracing the two blades using a structural reinforcement 23, as shown, it is contemplated that the two blades made be reinforced, structurally, by contact between the two blades near the tips.

Drag reduction has been proven in micro scale testing when blade thickness has been reduced. The NACA series of airfoils documented in aviation references include profiles that are as low as 6% thick, that is, have a maximum profile thickness of 6% of the chord length. Maximum profile thickness is generally found at the peak of the cambered (bent) mean line along the chord. Such reduced thicknesses and even less may be possible in the present invention, given that the blade thickness does not serve the same structural purposes as it does in current blades. A blade profile, using the NACA 4 digit convention, that may be suitable for use with the present invention is NACA 4406, with a large camber at the root and less at the blade tips. The generally high camber is a noteworthy benefit of the present “split” or doubled blade concept.

As shown in the Figures, the blade tips of the wind turbine blades of the present invention are separated from one another by a predetermined distance so as not to interfere substantially with the operation of each blade and not to add unduly to the blade grouping dimensions. It is contemplated that a variety of such distances may be utilized in accordance with the present invention, and the teachings herein are not limited to any specific distance. Further, while the blades of horizontal axis wind turbines are often oriented vertically with respect to the ground, or at least perpendicular to the main shaft, such an orientation is not necessary for use of the present invention. The main shafts may be angled upwards, and the blades may be canted forward at an angle other than perpendicular to the main shaft. The usefulness of such orientations lies in avoiding tower strikes by the blades, particularly when blade tips are bent back under the force of wind. Such orientations maybe employed in conjunction with the present invention. It is contemplated that various modifications to the present invention will be readily apparent to those of ordinary skill in the art upon reading this disclosure, and such modifications are contemplated to be within the spirit and scope of the present invention.

Having thus described the preferred embodiment of the invention, what is claimed as new and desired to be protected by Letters Patent includes the following:

1. A horizontal axis wind turbine blade grouping comprising:
at least two wind turbine blades, each of said blades having a blade root,
wherein said blade roots merge to form a single, unitary blade root structure.

2. The device according to claim 1, wherein said blade root structure further comprises at least one fastener for fastening said blade base structure to a hub of a wind turbine.

3. The device according to claim 2, wherein said turbine blade grouping comprises two turbine blades of substantially equal length.

4. The device according to claim 2, wherein said turbine blade grouping comprises two turbine blades of substantially different length.

5. The device according to claim 1, wherein each of said wind turbine blades comprises a profile that reduces blade drag and produces greater energy as compared to blades having a traditional profile.

6. The device according to claim 1, further comprising structural reinforcements extending between adjacent of said at least two wind turbine blades.

7. The device according to claim 1, wherein said at least two turbine blades have a gap therebetween, the dimensions of the gap determined to maximize aerodynamic and structural benefits.

8. A horizontal axis wind turbine blade assembly comprising:
at least two wind turbine blades, each of said blades comprising a blade root;
a first blade flange fixedly attached to the root of a first of said at least two wind turbine blades; and
a second blade flange fixedly attached to the root of a second of said at least two wind turbine blades,
wherein said first blade flange and said second blade flange are adapted to be attached to one another to form a single turbine blade assembly.

9. The wind turbine blade assembly according to claim 8 further comprising a hub flange adapted to receive said first blade flange and said second blade flange fastened thereto to form a single wind turbine blade assembly, the hub flange further adapted to be fixedly attached to a wind turbine hub.

10. The wind turbine blade assembly according to claim 8 wherein the first of said at least two wind turbine blades and the second of said at least two wind turbine blades are of substantially equal length.

11. The wind turbine blade assembly according to claim 8 wherein the first of said at least two wind turbine blades and the second of said at least two wind turbine blades are of substantially different lengths.

12. The wind turbine blade assembly according to claim 8 wherein each of said at least two wind turbine blades comprises a profile that reduces blade drag and produces greater energy as compared to blades having a traditional profile.

13. The wind turbine blade assembly according to claim 8 further comprising a structural reinforcement extending between adjacent of said at least two wind turbine blades.

14. The wind turbine blade assembly according to claim 8 wherein said at at least two turbine blades have a gap therebetween, the dimensions of the gap determined to maximize aerodynamic and structural benefits.
